(19) United States
(12) Patent Application Publication
(10) Pub. No.: US 2009/0279031 A1
(43) Pub. Date: Nov. 12, 2009

(54) LIQUID CRYSTAL PANEL AND LIQUID CRYSTAL DISPLAY APPARATUS USING THE SAME

(75) Inventors: Takeharu Kitagawa, Osaka (JP); Kentarou Takeda, Osaka (JP); Yoshiyuki Kiya, Osaka (JP); Nao Murakami, Osaka (JP); Shuusaku Nakano, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 12/064,777

(22) PCT Filed: Aug. 9, 2006
(86) PCT No.: PCT/JP2006/315712

§ 371 Date: Feb. 25, 2008

(30) Foreign Application Priority Data
Aug. 23, 2005 (JP) 2005-240587
Mar. 2, 2006 (JP) 2006-056700

(51) Int. Cl. G02F 1/13363

(52) U.S. Cl. 349/118

(57) ABSTRACT

A liquid crystal display apparatus is provided, in which excellent viewing angle compensation is conducted, and which is highly excellent in a contrast in an oblique direction and can be reduced in thickness. A liquid crystal panel of the present invention includes a first polarizer, a first optical compensation layer, a liquid crystal cell, a second optical compensation layer, and a second polarizer in the stated order. Each of the first optical compensation layer and the second optical compensation layer contains at least one polymer selected from the group consisting of polyimide, polyamide, polyester, polyetherketone, polyamideimide, and polyesterimide, and have a refractive index profile of nx>ny>nz.

### TECHNICAL FIELD

The present invention relates to a liquid crystal panel and a liquid crystal display apparatus using the liquid crystal panel. More specifically, the present invention relates to a liquid crystal panel with a very small color shift and a liquid crystal display apparatus using the liquid crystal panel.

### BACKGROUND ART

For example, in a liquid crystal cell of a VA mode, liquid crystal molecules are aligned in a vertical direction, so the liquid crystal molecules are apparently aligned in an oblique direction in the case where a liquid crystal panel is observed from a direction shifted from a normal direction. As a result, there arises a problem that light leakage occurs due to the influence of birefringence of the liquid crystal molecules, which narrows a viewing angle.

Further, in the case where a polarizing plate in which absorption axes are placed so as to be perpendicular to each other on both sides of a liquid crystal cell is observed from a normal direction of a liquid crystal panel, light leakage does not occur. However, when the observation angle is changed from the normal direction at an azimuth shifted from the absorption axis direction, the absorption axes of the polarizing plate apparently become non-perpendicular to cause light leakage.

In order to solve such a problem, the technology of compensating for the influence of the birefringence of liquid crystal molecules and the axis shift of a polarizing plate on light leakage by using a biaxial optical compensation plate having a refractive index profile of nx>ny>nz has been proposed (for example, see Patent Documents 1 to 3). However, none of these technologies can reduce a color shift sufficiently.

### Patent Document 1: JP Patent Application No. 2003-926 (JP 2003-270442A)

### Patent Document 2: JP Patent Application No. 2003-27488 (JP 2004-4550A)

### Patent Document 3: JP Patent Application No. 2003-38734 (JP 2003-315555A)

### DISCLOSURE OF THE INVENTION

### Problem to be Solved by the Invention

The present invention has been made in view of solving the above-mentioned problem, and an object of the present invention is therefore to provide a liquid crystal display panel having a very small color shift and a liquid crystal display apparatus using the liquid crystal panel.

### Means for Solving the Problems

A liquid crystal panel of the present invention includes a first polarizer, a first optical compensation layer, a liquid crystal cell, a second optical compensation layer, and a second polarizer in the stated order, in which the first optical compensation layer and the second optical compensation layer each contain at least one polymer selected from the group consisting of polyimide, polyamide, polyester, polyetherketone, polyamideimide, and polyesterimide, and have a refractive index profile of nx>ny>nz, where nx represents a refractive index in a slow axis direction of the optical compensation layer, ny represents a refractive index in a fast axis direction of the optical compensation layer, and nz represents refractive index in a thickness direction of the optical compensation layer.

In a preferred embodiment, each of the first optical compensation layer and the second optical compensation layer has a thickness of 0.5 to 10 μm.

In a preferred embodiment, each of the first optical compensation layer and the second optical compensation layer has a Nz coefficient of 2≦Nz≦20.

In a preferred embodiment, the liquid crystal panel further includes a first protective layer between the first optical compensation layer and the first polarizer, and a second protective layer between the second optical compensation layer and the second polarizer. In a further preferred embodiment, the first protective layer and the second protective layer each contain a cellulose-based polymer, and a thickness direction retardation Rth of at least one of the first protective layer and the second protective layer is 30 nm or less, where the thickness direction retardation Rth is represented by an expression of Rth=(nx−nz)×d, nx is a refractive index in a slow axis direction of the optical compensation layer, nz is a refractive index in a thickness direction of the optical compensation layer, and d is a thickness of the optical compensation layer.

In a preferred embodiment, the liquid crystal cell is a VA mode or an OCB mode.

According to another aspect of the present invention, a liquid crystal display apparatus is provided. The liquid crystal display apparatus includes the above liquid crystal panel.

### EFFECTS OF THE INVENTION

As described above, according to the present invention, a color shift can be reduced remarkably by placing particular optical compensation layers on both sides of a liquid crystal cell, compared with the case of placing an optical compensation layer on one side. In a preferred embodiment, the optical compensation layers placed on both sides of the liquid crystal cell have the same properties (for example, a constituent material, optical properties, thickness). Such a symmetrical arrangement can further reduce a color shift. In a preferred embodiment, a color shift can be further reduced by placing a protective layer having a small thickness direction retardation between the optical compensation layer and a polarizer. Though the effect obtained by placing the particular optical compensation layers on both sides of the liquid crystal cell is not theoretically clear, it can be presumed as follows. The liquid crystal cell in the present invention mainly relates to a VA mode or an OCB mode and has positive wave length dispersion characteristics in which a retardation decreases with an increase in wavelength, with the tilt thereof being large. A non-liquid crystalline material such as polyimide in the present invention similarly has positive wavelength dispersion characteristics, with the tilt thereof being large. Therefore, by placing such a material on both sides of the liquid crystal cell, the wavelength dispersion characteristics thereof are well matched with those of the liquid crystal cell, which enhances optical properties.

### BRIEF DESCRIPTION OF THE DRAWINGS

FIG. 1 is a schematic cross-sectional view of a liquid crystal panel according to a preferred embodiment of the present invention.

FIG. 2 are schematic cross-sectional views illustrating alignment states of liquid crystal molecules in a liquid crystal layer in a case where a liquid crystal display apparatus of the present invention adopts a liquid crystal cell of a VA mode.

FIG. 3 are schematic cross-sectional views illustrating alignment states of liquid crystal molecules in a liquid crystal layer in a case where the liquid crystal display apparatus of the present invention adopts a liquid crystal cell of an OCB mode.

FIG. 4 is a graph showing a relationship between an x-value and a y-value, and an azimuth angle of a liquid crystal panel of Example 1.

FIG. 5 is an xy chromaticity diagram of the liquid crystal panel of Example 1.

FIG. 6 is a graph showing a relationship between an x-value and a y-value, and an azimuth angle of a liquid crystal panel of Example 2.

FIG. 7 is a graph showing a relationship between an x-value and a y-value, and an azimuth angle of a liquid crystal panel of Comparative Example 1.

FIG. 8 is an xy chromaticity diagram of the liquid crystal panel of Comparative Example 1.

FIG. 9 is a graph showing a relationship between an x-value and a y-value, and an azimuth angle of a liquid crystal panel of Comparative Example 2.

FIG. 10 is a graph showing a relationship between an x-value and a y-value, and an azimuth angle of a liquid crystal panel of Comparative Example 3.

### DESCRIPTION OF SYMBOLS

10 first polarizer
20 first optical compensation layer
30 liquid crystal cell
40 second optical compensation layer
50 second polarizer
100 liquid crystal display apparatus

### BEST MODE FOR CARRYING OUT THE INVENTION

### A. Overall Configuration of a Liquid Crystal Panel

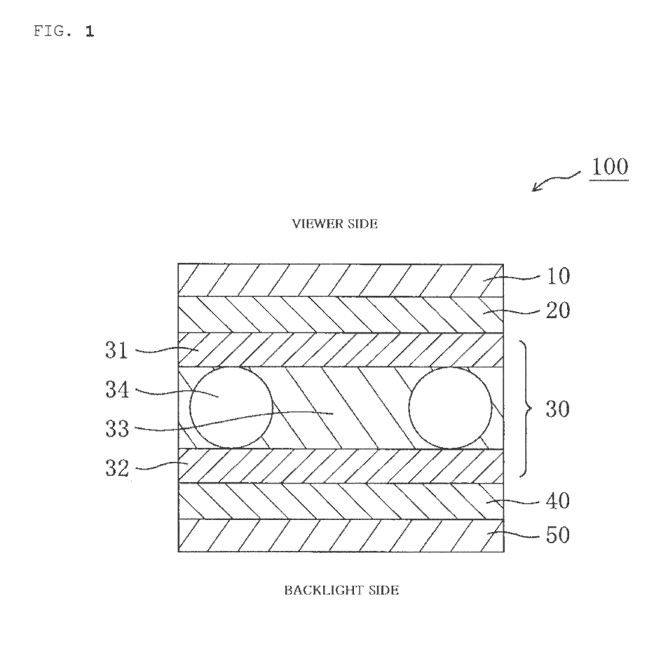

FIG. 1 is a schematic cross-sectional view of a liquid crystal panel according to a preferred embodiment of the present invention. In the illustrated example, a liquid crystal panel 100 includes a first polarizer 10, a first optical compensation layer 20, a liquid crystal cell 30, a second optical compensation layer 40, and a second polarizer 50 from a viewer side in the stated order. The first polarizer 10 and the second polarizer 50 are generally placed such that absorption axes thereof are perpendicular to each other. The liquid crystal cell 30 includes a pair of glass substrates 31 and 32 and a liquid crystal layer 33 as a display medium placed between the substrates. One substrate (active matrix substrate) 32 is provided with a switching element (TFT, in general) for controlling electrooptic properties of liquid crystal, and a scanning line for providing a gate signal to the switching element and a signal line for providing a source signal thereto (both element and lines are not shown). The other glass substrate (color filter substrate) 31 is provided with a color filter (not shown). The color filter may be provided on the active matrix substrate 32. A space (cell gap) between the substrates 31 and 32 is controlled by a spacer 34. An orientated film (not shown) formed of, for example, polyimide is provided on a side of each of the substrates 31 and 32 in contact with the liquid crystal layer 33.

Preferably, a first protective layer (not shown) is provided between the first optical compensation layer 20 and the first polarizer 10, and a second protective layer (not shown) is provided between the second optical compensation layer 40 and the second polarizer 50. Further, practically, another protective layer (not shown) is provided on an opposite side (an outer side of the first polarizer 10, the viewer side in the illustrated example) of the first optical compensation layer 20 of the first polarizer 10 is provided, and still another protective layer (not shown) is provided on an opposite side (an outer side of the second polarizer 50, a backlight side in the illustrated example) of the second optical compensation layer 40 of the second polarizer 50.

Any appropriate drive mode can be employed for drive mode of the liquid crystal cell 30 as long as effects of the present invention can be obtained. Specific examples of the drive mode include STN (Super Twisted Nematic) mode, TN (Twisted Nematic) mode, IPS (In-Plane Switching) mode, VA (Vertical Aligned) mode, OCB (Optically Aligned Birefringence) mode, HAN (Hybrid Aligned Nematic) mode, and ASM (Axially Symmetric Aligned Microcell) mode. The VA mode and the OCB mode are preferred because of their remarkable improvements in color shifts.

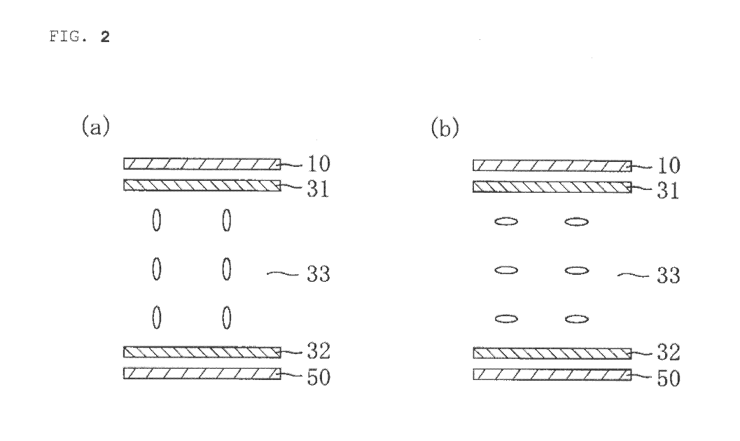

FIGS. 2A and 2B are each a schematic sectional view explaining an alignment state of liquid crystal molecules in VA mode. As shown in FIG. 2A, the liquid crystal molecules are aligned vertically to surfaces of the substrates 31 and 32 under no voltage application. Such vertical alignment may be realized by arranging nematic liquid crystals having negative dielectric anisotropy between substrates each having formed thereon a vertically aligned film (not shown). Light enters from a surface of one substrate 32 in such a state, and linear polarized light allowed to pass through the polarizer 50 and to enter the liquid crystal layer 33 advances along long axes of vertically aligned liquid crystal molecules. No birefringence generates in a long axis direction of the liquid crystal molecules such that incident light advances without changing a polarization direction and is absorbed by the polarizer 10 having a absorption axis perpendicular to the polarizer 50. In this way, dark display is obtained under no voltage application (normally black mode). As shown in FIG. 2B, long axes of the liquid crystal molecules align parallel to the surfaces of the substrates under voltage application between electrodes. The liquid crystal molecules exhibit birefringence with respect to linear polarized light entering the liquid crystal layer 33 in such a state, and a polarization state of incident light varies depending on inclination of the liquid crystal molecules. Light allowed to pass through the liquid crystal layer under application of a predetermined maximum voltage rotates its polarization direction by 90°, for example, into linear polarized light and passes through the polarizer 10, to thereby provide light display. Return to a state under no voltage application provides dark display again by alignment control force. The inclination of the liquid crystal molecules is controlled by varying an application voltage. Therefore, an intensity of transmitted light from the polarizer 10 may change, to thereby provide gradient display.

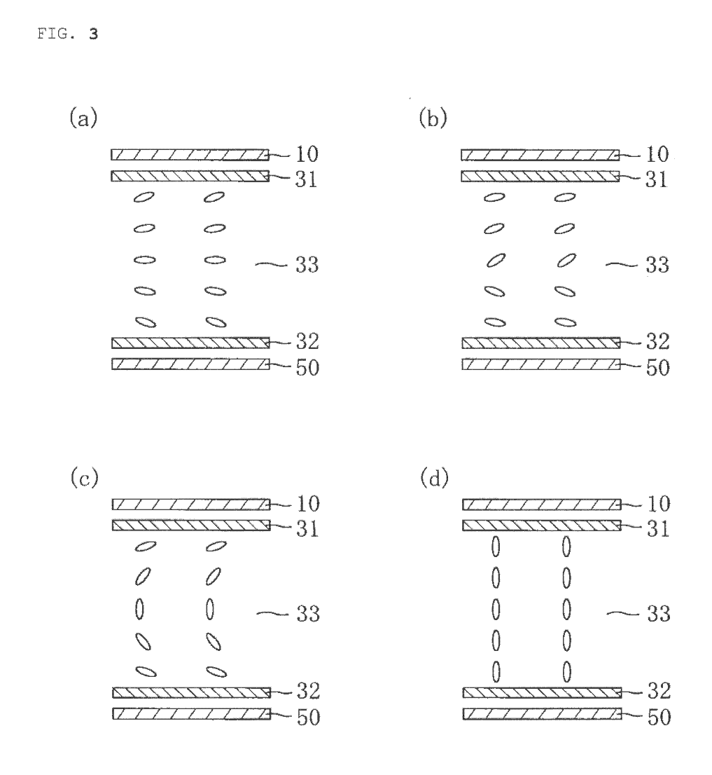

FIGS. 3A to 3D are each a schematic sectional view explaining an alignment state of liquid crystal molecules in OCB mode. The OCB mode refers to drive mode in which the liquid crystal layer 33 is formed of so-called bend alignment. As shown in FIG. 3C, the bend alignment refers to an alignment state in which: nematic liquid crystal molecules are aligned at a substantially parallel angle (alignment angle) in a vicinity of a substrate; the alignment angle forms a vertical angle with respect to a plane of the substrate toward the center of the liquid crystal layer; the alignment changes progressively and continuously to be parallel to the opposing substrate surface away from the center of the liquid crystal layer; and no twisted structure exists throughout the liquid crystal layer. Such bend alignment is formed as described below. As shown in FIG. 3A, the liquid crystal molecules have substantially homogenous alignment in a state in the absence of an electric field (initial state). However, the liquid crystal molecules each have a pretilt angle, and a pretilt angle in the vicinity of the substrate differs from a pretilt angle in the vicinity of the opposing substrate. Upon application of a predetermined bias voltage (typically, 1.5 V to 1.9 V) (under low voltage application), the liquid crystal molecules undergo a spray alignment as shown in FIG. 3B and transfer to a bend alignment as shown in FIG. 3C. Upon application of a display voltage (typically, 5 V to 7 V) (under high voltage application), the liquid crystal molecules in a bend alignment state align substantially vertically to the surface of the substrate as shown in FIG. 3D. In normally white display mode, light allowed to pass through the polarizer 50 and to enter the liquid crystal layer 33 in a state as shown in FIG. 3D under high voltage application advances without changing a polarization direction and is absorbed by the polarizer 10, to thereby provide dark display. Reduction in display voltage returns the liquid crystal molecules into bend alignment by alignment control force of rubbing treatment, to thereby provide light display again. The inclination of the liquid crystal molecules is controlled by varying a display voltage. Therefore, an intensity of transmitted light from the polarizer may change, to thereby provide gradient display. A liquid crystal display apparatus provided with a liquid crystal cell of OCB mode allows very high speed switching of phase transfer from spray alignment state to bend alignment state, and thus has a characteristic of better movie display properties than those of a liquid crystal display apparatus provided with a liquid crystal cell of other drive mode such as TN mode or IPS mode.

### B. Optical Compensation Layer

### B-1. Properties of an Optical Compensation Layer

An in-plane retardation (front retardation) Δnd₁ of the first optical compensation layer 20 can be optimized so as to correspond to the driving mode of a liquid crystal cell. An in-plane retardation Δnd₂ of a second optical compensation layer 40 can also be optimized so as to correspond to the driving mode of the liquid crystal cell. As long as the effects of the present invention are obtained, Δnd₁ and Δnd₂ may be the same as or different to each other. Preferably, the in-plane retardations of the respective optical compensation layers are the same. This is because the effect of improving a color shift is remarkable. For example, the lower limits of each of Δnd₁ and Δnd₂ are preferably 5 nm or more, more preferably 10 nm or more, and most preferably 15 nm or more. In the case where Δnd₁ or Δnd₂ is less than 5 nm, the contrast in an oblique direction decreases in most cases. On the other hand, the upper limits of each of Δnd₁ and Δnd₂ are preferably 400 nm or less, more preferably 300 nm or less, much more preferably 200 nm or less, particularly preferably 150 nm or less, especially preferably 100 nm or less, and most preferably 80 nm or less. When Δnd₁ or Δnd₂ exceeds 400 nm, the viewing angle becomes small in most cases. More specifically, in a case where a liquid crystal cell adopts a VA mode, each of Δnd₁ and Δnd₂ is preferably 5 to 100 nm, more preferably 10 to 70 mm, and most preferably 30 to 50 nm. In a case where the liquid crystal cell adopts an OCB mode, each of Δnd₁ and Δnd₂ is preferably 5 to 400 nm, more preferably 10 to 300 nm, and most preferably 15 to 200 nm. An in-plane retardation And is obtained by an expression: Δnd=(nx-ny)×d. Herein, nx represents a refractive index in a slow axis direction of an optical compensation layer, ny represents a refractive index in a fast axis direction of an optical compensation layer, and d(nm) represents the thickness of an optical compensation layer. Typically, Δnd is measured using light having a wavelength of 590 nm. The slow axis refers to a direction in which the refractive index in a film plane becomes maximum, and the fast axis refers to a direction perpendicular to the slow axis in a plane.

A thickness direction retardation Rth₁ of the first optical compensation layer 20 can also be optimized so as to correspond to the driving mode of a liquid crystal cell. Further, a thickness direction retardation Rth₂ of a second optical compensation layer 40 can also be optimized so as to correspond to the driving mode of the liquid crystal cell. As long as the effects of the present invention are obtained, Rth₁ and Rth₂ may be the same as or different to each other. Preferably, the thickness direction retardations of the respective optical compensation layers are the same. This is because the effect of improving a color shift is remarkable. For example, the lower limits of each of Rth₁ and Rth₂ are preferably 10 nm or more, more preferably 20 nm or more, and most preferably 50 nm or more. In the case where Rth₁ or Rth₂ is less than 10 nm, the contrast in an oblique direction decreases in most cases. On the other hand, the upper limits of each of Rth₁ and Rth₂ are respectively preferably 1,000 nm or less, more preferably 500 nm or less, much more preferably 400 nm or less, particularly preferably 300 nm or less, especially preferably 280 nm or less, and most preferably 260 nm or less. When Rth₁ or Rth₂ exceeds 1,000 nm, the optical compensation becomes too high, and as a consequence, the contrast in an oblique direction may decrease. More specifically, in a case where a liquid crystal cell adopts a VA mode, each of Rth₁ and Rth₂ is preferably 10 to 300 nm, more preferably 20 to 250 mm, and most preferably 50 to 200 nm. In the case where the liquid crystal cell adopts an OCB mode, each of Rth₁ and Rth₂ is preferably 10 to 1,000 nm, more preferably 20 to 500 nm, and most preferably 50 to 400 nm. A thickness direction retardation Rth is obtained by an expression: Rth=(nx−nz)×d. Herein, nz represents a refractive index in thickness direction of a film (optical compensation layer). Typically, Rth is also measured using light having a wavelength of 590 nm.

The Nz coefficient (=Rth/Δnd) of the first optical compensation layer 20 can also be optimized so as to correspond to the driving mode of a liquid crystal cell. Further, the Nz coefficient of the second optical compensation layer 40 can also be optimized so as to correspond to the driving mode of the liquid crystal cell. As long as the effects of the present invention are obtained, the Nz coefficients of the first optical compensation layer 20 and the second optical compensation layer 40 may be the same as or different to each other. Preferably, the Nz coefficients of each of the optical compensation layers are the same. This is because the effect of improving a color shift is remarkable. For example, the Nz coefficient of each of the first optical compensation layer 20 and the second optical compensation layer 40 is preferably 2 to 20, more preferably 2 to 10, especially preferably 2 to 8, and most preferably 2 to 6. More specifically, in a case where the liquid crystal cell adopts a VA mode, the Nz coefficient of each of the first optical compensation layer 20 and the second optical compensation layer 40 is preferably 2 to 10, more preferably 2 to 8, and most preferably 2 to 6. In a case where the liquid crystal cell adopts an OCB mode, the Nz coefficient of each of the first optical compensation layer 20 and the second optical compensation layer 40 is preferably 2 to 20, more preferably 2 to 10, and most preferably 2 to 8. Further, each of the first optical compensation layer 20 and the second optical compensation layer 40 has a refractive index profile of nx>ny>nz. By placing an optical compensation layer having such optical properties (i.e., And, Rth, a refractive index profile, and a Nz coefficient) on both sides of a liquid crystal cell (more preferably, by placing the same optical compensation layer in a symmetrical manner), a liquid crystal panel with a very small color shift is obtained.

Each of the first optical compensation layer 20 and the second optical compensation layer 40 can have any appropriate thickness as long as the effects of the present invention are exhibited. Specifically, the thickness of each of the first optical compensation layer 20 and the second optical compensation layer 40 is preferably to 50 μm, more preferably 0.5 to 30 μm, particularly preferably to 10 μm, especially preferably 1 to 10 μm, and most preferably to 5 μm. This is because such thicknesses can contribute to the reduction in thickness of a liquid crystal display apparatus, and enables an optical compensation layer with excellent viewing angle compensation performance and a uniform retardation to be obtained. The thicknesses of the first optical compensation layer 20 and the second optical compensation layer 40 may be the same as or different to each other. Preferably, the thickness of each of the optical compensation layers is the same. This is because the effect of improving a color shift is remarkable.

Each of the first optical compensation layer 20 and the second optical compensation layer 40 may be a single layer or a laminate of at least two layers. In the case of the laminate, the material constituting each layer and the thickness of each layer can be appropriately set as long as the whole laminate has the above-mentioned optical properties.

### B-2. Constituent Material for an Optical Compensation Layer

As the materials constituting the first optical compensation layer 20 and the second optical compensation layer 40, any appropriate materials can be adopted as long as the above-mentioned optical properties are obtained. As long as the effects of the present invention are obtained, the first optical compensation layer 20 and the second optical compensation layer 40 may be composed of the same material as or different materials to each other. An example of the material for the optical compensation layer includes a non-liquid crystalline material. The material is particularly preferably a non-liquid crystalline polymer. The non-liquid crystalline material differs from a liquid crystal material and may form an optically uniaxial film with nx>nz and ny>nz as a property of the non-liquid crystalline material, regardless of orientation of the substrate. As a result, the non-liquid crystalline material may employ not only an orientated substrate, but also an unorientated substrate. Further, a step of applying an orientated film on a substrate surface, a step of laminating an orientated film, and the like may be omitted even when an unorientated substrate is employed.

A preferable example of the non-liquid crystalline material includes a polymer such as polyamide, polyimide, polyester, polyetherketone, polyamideimide, or polyesterimide for excellent thermal resistance, excellent chemical resistance, excellent transparency, and sufficient rigidity. One type of polymer may be used, or a mixture of two or more types thereof having different functional groups such as a mixture of polyaryletherketone and polyamide may be used. Of those polymers, polyimide is particularly preferable for high transparency, high orientation, and high extension. Polyimide is preferred because it has a positive wavelength dispersion characteristic in which a retardation decreases with the increase in a wavelength, and its inclination is optimally matched with that of the wavelength dispersion characteristic of a liquid crystal cell of a VA mode or an OCB mode.

A molecular weight of the polymer is not particularly limited. However, the polymer has a weight average molecular weight (Mw) of preferably within a range of 1,000 to 1,000,000, more preferably within a range of 2,000 to 500,000, for example.

Polyimide which has high in-plane alignment ability and which is soluble in an organic solvent is preferred as polyimide used in the present invention, for example. More specifically, a polymer disclosed in JP 2000-511296 A, containing a condensation polymerization product of 9,9-bis(aminoaryl) fluorene and aromatic tetracarboxylic dianhydride, and containing at least one repeating unit represented by the following formula (1) can be used.

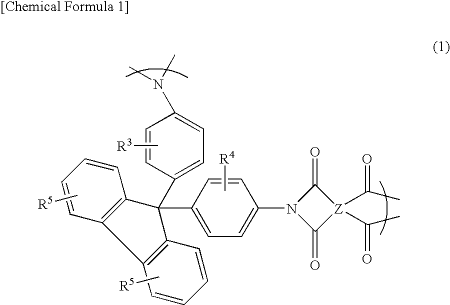

In the above formula (1), R³ to R⁶ independently represent at least one type of substituent selected from hydrogen, a halogen, a phenyl group, a phenyl group substituted with 1 to 4 halogen atoms or 1 to 4 alkyl groups each having 1 to 10 carbon atoms, and an alkyl group having 1 to 10 carbon atoms. Preferably, R³ to R⁶ independently represent at least one type of substituent selected from a halogen, a phenyl group, a phenyl group substituted with to 4 halogen atoms or 1 to 4 alkyl groups each having 1 to 10 carbon atoms, and an alkyl group having 1 to 10 carbon atoms.

In the above formula (1), Z represents a tetravalent aromatic group having 6 to 20 carbon atoms, and preferably represents a pyromellitic group, a polycyclic aromatic group, a derivative of the polycyclic aromatic group, or a group represented by the following formula (2), for example.

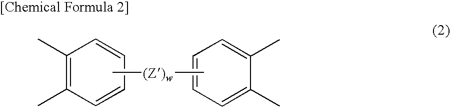

In the above formula (2), Z′ represents a covalent bond, a C(R⁷)₂ group, a CO group, an O atom, an S atom, an SO₂ group, an Si(C₂H₅)₂ group, or an NR⁸ group. A plurality of Z's may be the same or different from each other. w represents an integer of 1 to 10. R⁷s independently represent hydrogen or a C(R⁹)₃ group. R represents hydrogen, an alkyl group having 1 to about 20 carbon atoms, or an aryl group having 6 to 20 carbon atoms. A plurality of R⁸s may be the same or different from each other. R⁹s independently represent hydrogen, fluorine, or chlorine.

An example of the polycyclic aromatic group includes a tetravalent group derived from naphthalene, fluorene, benzofluorene, or anthracene. An example of the substituted derivative of the polycyclic aromatic group includes the above polycyclic aromatic group substituted with at least a group selected from an alkyl group having 1 to 10 carbon atoms, a fluorinated derivative thereof, and a halogen such as F or Cl.

Other examples of the polyimide include: a homopolymer disclosed in JP 08-511812 A and containing a repeating unit represented by the following general formula (3) or (4); and polyimide disclosed therein and containing a repeating unit represented by the following general formula (5). Note that, polyimide represented by the following formula (5) is a preferred form of the homopolymer represented by the following formula (3).

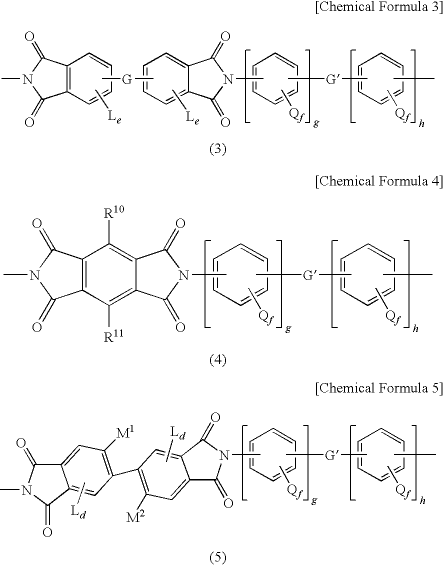

In the above general formulae (3) to (5), G and G′ independently represent a covalent bond, a CH₂ group, a C(CH₃)₂ group, a C(CF₃)₂ group, a C(CX₃)₂ group (wherein, X represents a halogen), a CO group, an O atom, an S atom, an SO₂ group, an Si (CH₂CH₃)₂ group, or an N(CH₃) group, for example. G and G′ may be the same or different from each other.

In the above formulae (3) and (5), L is a substituent, and d and e each represent the number of the substituents. L represents a halogen, an alkyl group having 1 to 3 carbon atoms, a halogenated alkyl group having 1 to 3 carbon atoms, a phenyl group, or a substituted phenyl group, for example. A plurality of Ls may be the same or different from each other. An example of the substituted phenyl group includes a substituted phenyl group having at least one type of substituent selected from a halogen, an alkyl group having 1 to 3 carbon atoms, and a halogenated alkyl group having 1 to 3 carbon atoms, for example. Examples of the halogen include fluorine, chlorine, bromine, and iodine. d represents an integer of 0 to 2, and e represents an integer of 0 to 3.

In the above formulae (3) to (5), Q is a substituent, and f represents the number of the substituents. Q represents an atom or a group selected from hydrogen, a halogen, an alkyl group, a substituted alkyl group, a nitro group, a cyano group, a thioalkyl group, an alkoxy group, an aryl group, a substituted aryl group, an alkylester group, and a substituted alkylester group, for example. A plurality of Qs may be the same or different from each other. Examples of the halogen include fluorine, chlorine, bromine, and iodine. An example of the substituted alkyl group includes a halogenated alkyl group. An example of the substituted aryl group includes a halogenated aryl group. f represents an integer of 0 to 4, and g represents an integer of 0 to 3. h represents an integer of 1 to 3. g and h are each preferably larger than l.

In the above formula (4), R¹⁰ and R¹¹ independently represent an atom or a group selected from hydrogen, a halogen, a phenyl group, a substituted phenyl group, an alkyl group, and a substituted alkyl group. Preferably, R¹⁰ and R¹¹ independently represent a halogenated alkyl group.

In the above formula (5), M¹ and M² independently represent a halogen, an alkyl group having 1 to 3 carbon atoms, a halogenated alkyl group having 1 to 3 carbon atoms, a phenyl group, or a substituted phenyl group, for example. Examples of the halogen include fluorine, chlorine, bromine, and iodine. An example of the substituted phenyl group includes a substituted phenyl group having at least one type of substituent selected from the group consisting of a halogen, an alkyl group having 1 to 3 carbon atoms, and a halogenated alkyl group having 1 to 3 carbon atoms.

A specific example of the polyimide represented by the above formula (3) includes a compound represented by the following formula (6).

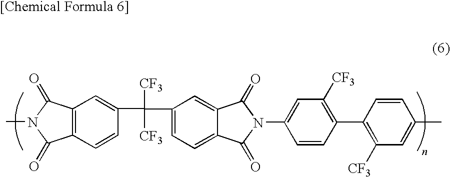

Another example of the polyimide includes a copolymer prepared through arbitrary copolymerization of acid dianhydride having a skeleton (repeating unit) other than that as described above and diamine.

An example of the acid dianhydride includes an aromatic tetracarboxylic dianhydride. Examples of the aromatic tetracarboxylic dianhydride include pyromellitic dianhydride, benzophenone tetracarboxylic dianhydride, naphthalene tetracarboxylic dianhydride, heterocyclic aromatic tetracarboxylic dianhydride, and 2,2′-substituted biphenyltetracarboxylic dianhydride.

Examples of the pyromellitic dianhydride include: pyromellitic dianhydride; 3,6-diphenyl pyromellitic dianhydride; 3,6-bis(trifluoromethyl)pyromellitic dianhydride; 3,6-dibromopyromellitic dianhydride; and 3,6-dichloropyromellitic dianhydride. Examples of the benzophenone tetracarboxylic dianhydride include: 3,3′,4,4′-benzophenone tetracarboxylic dianhydride; 2,3,3′,4′-benzophenone tetracarboxylic dianhydride; and 2,2′,3,3′-benzophenone tetracarboxylic dianhydride. Examples of the naphthalene tetracarboxylic dianhydride include: 2,3,6,7-naphthalene tetracarboxylic dianhydride; 1,2,5,6-naphthalene tetracarboxylic dianhydride; and 2,6-dichloronaphthalene-1,4,5,8-tetracarboxylic dianhydride. Examples of the heterocyclic aromatic tetracarboxylic dianhydride include: thiophene-2,3,4,5-tetracarboxylic dianhydride; pyrazine-2,3,5,6-tetracarboxylic dianhydride; and pyridine-2,3,5,6-tetracarboxylic dianhydride. Examples of the 2,2′-substituted biphenyltetracarboxylic dianhydride include: 2,2′-dibromo-4,4′,5,5′-biphenyltetracarboxylic dianhydride; 2,2′-dichloro-4,4′,5,5′-biphenyltetracarboxylic dianhydride; and 2,2′-bis(trifluoromethyl)-4,4′,5,5′-biphenyltetracarboxylic dianhydride.

Further examples of the aromatic tetracarboxylic dianhydride include: 3,3′,4,4′-biphenyltetracarboxylic dianhydride; bis(2,3-dicarboxyphenyl)methane dianhydride; bis(2,5,6-trifluoro-3,4-dicarboxyphenyl)methane dianhydride; 2,2-bis(3,4-dicarboxyphenyl)-1,1,1,3,3,3-hexafluoropropane dianhydride; 4,4′-bis(3,4-dicarboxyphenyl)-2,2-diphenylpropane dianhydride; bis(3,4-dicarboxyphenyl)ether dianhydride; 4,4′-oxydiphthalic dianhydride; bis(3,4-dicarboxyphenyl) sulfonic dianhydride; 3,3′,4,4′-diphenylsulfone tetracarboxylic dianhydride; 4,4′-[4,4′-isopropylidene-di(p-phenyleneoxy)]bis(phthalic anhydride); N,N-(3,4-dicarboxyphenyl)-N-methylamine dianhydride; and bis(3,4-dicarboxyphenyl)diethylsilane dianhydride.

Of those, the aromatic tetracarboxylic dianhydride is preferably 2,2′-substituted biphenyltetracarboxylic dianhydride, more preferably 2,2′-bis(trihalomethyl)-4,4′,5,5′-biphenyltetracarboxylic dianhydride, and furthermore preferably 2,2′-bis(trifluoromethyl)-4,4′,5,5′-biphenyltetracarboxylic dianhydride.

An example of the diamine includes aromatic diamine. Specific examples of the aromatic diamine include benzenediamine, diaminobenzophenone, naphthalenediamine, heterocyclic aromatic diamine, and other aromatic diamines.

Examples of the benzenediamine include benzenediamines such as o-, m-, or p-phenylenediamine, 2,4-diaminotoluene, 1,4-diamino-2-methoxybenzene, 1,4-diamino-2-phenylbenzene, and 1,3-diamino-4-chlorobenzene. Examples of the diaminobenzophenone include 2,2′-diaminobenzophenone and 3,3′-diaminobenzophenone. Examples of the naphthalenediamine include 1,8-diaminonaphthalene and 1,5-diaminonaphthalene. Examples of the heterocyclic aromatic diamine include 2,6-diaminopyridine, 2,4-diaminopyridine, and 2,4-diamino-S-triazine.

Further examples of the aromatic diamine include: 4,4′-diaminobiphenyl; 4,4′-diaminodiphenylmethane; 4,4′-(9-fluorenylidene)-dianiline; 2,2′-bis(trifluoromethyl)-4,4′-diaminobiphenyl; 3,3′-dichloro-4,4′-diaminodiphenylmethane; 2,2′-dichloro-4,4′-diaminobiphenyl; 2,2′,5,5′-tetrachlorobenzidine; 2,2-bis(4-aminophenoxyphenyl)propane; 2,2-bis(4-aminophenyl)propane; 2,2-bis(4-aminophenyl)-1,1,1,3,3,3-hexafluoropropane; 4,4′-diaminodiphenyl ether; 3,4′-diaminodiphenyl ether; 1,3-bis(3-aminophenoxy)benzene; 1,3-bis(4-aminophenoxy)benzene; 1,4-bis(4-aminophenoxy)benzene; 4,4′-bis(4-aminophenoxy)biphenyl; 4,4′-bis(3-aminophenoxy)biphenyl; 2,2-bis[4-(4-aminophenoxy)phenyl]propane; 2,2-bis[4-(4-aminophenoxy)phenyl]-1,1,1,3,3,3-hexafluoropropane; 4,4′-diaminodiphenyl thioether; and 4,4′-diaminodiphenylsulfone.

An example of the polyetherketone includes polyaryletherketone disclosed in JP 2001-049110 A and represented by the following general formula (7).

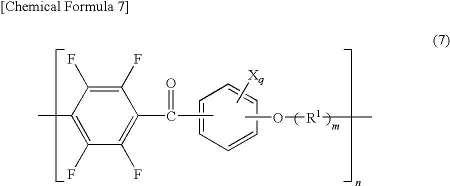

In the above formula (7), X represents a substituent, and q represents the number of the substituents. X represents a halogen atom, a lower alkyl group, a halogenated alkyl group, a lower alkoxy group, or a halogenated alkoxy group, for example. A plurality of Xs may be the same or different from each other.

Examples of the halogen atom include a fluorine atom, a bromine atom, a chlorine atom, and an iodine atom. Of those, a fluorine atom is preferred. The lower alkyl group is preferably an alkyl group having a straight chain or branched chain of 1 to 6 carbon atoms, more preferably an alkyl group having a straight chain or branched chain of 1 to 4 carbon atoms. More specifically, the lower alkyl group is preferably a methyl group, an ethyl group, a propyl group, an isopropyl group, a butyl group, an isobutyl group, a sec-butyl group, or a tert-butyl group, and particularly preferably a methyl group or an ethyl group. An example of the halogenated alkyl group includes a halide of the above lower alkyl group such as a trifluoromethyl group. The lower alkoxy group is preferably an alkoxy group having a straight chain or branched chain of 1 to 6 carbon atoms, more preferably an alkoxy group having a straight chain or branched chain of 1 to 4 carbon atoms. More specifically, the lower alkoxy group is preferably a methoxy group, an ethoxy group, a propoxy group, an isopropoxy group, a butoxy group, an isobutoxy group, a sec-butoxy group, or a tert-butoxy group, and particularly preferably a methoxy group or an ethoxy group. An example of the halogenated alkoxy group includes a halide of the above lower alkoxy group such as a trifluoromethoxy group.

In the above formula (7), q is an integer of 0 to 4. In the above formula (7), preferably, q=0, and a carbonyl group and an oxygen atom of ether bonded to both ends of a benzene ring are located in para positions.

In the above formula (7), R¹ is a group represented by the following formula (8), and m is an integer of 0 or 1.

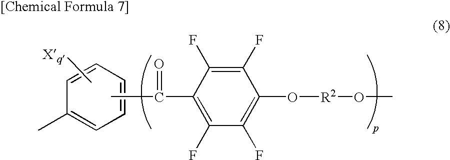

In the above formula (8), X′ represents a substituent which is the same as X in the above formula (7), for example. In the above formula (8), a plurality of X's may be the same or different from each other. q, represents the number of the substituents X′. q′ is an integer of 0 to 4, and q′ is preferably 0. p is an integer of 0 or 1.

In the above formula (8), R² represents a divalent aromatic group. Examples of the divalent aromatic group include: an o-, m-, or p-phenylene group; and a divalent group derived from naphthalene, biphenyl, anthracene, o-, m-, or p-terphenyl, phenanthrene, dibenzofuran, biphenyl ether, or biphenyl sulfone. In the divalent aromatic group, hydrogen directly bonded to an aromatic group may be substituted with a halogen atom, a lower alkyl group, or a lower alkoxy group. Of those, R² is preferably an aromatic group selected from groups represented by the following formulae (9) to (15).

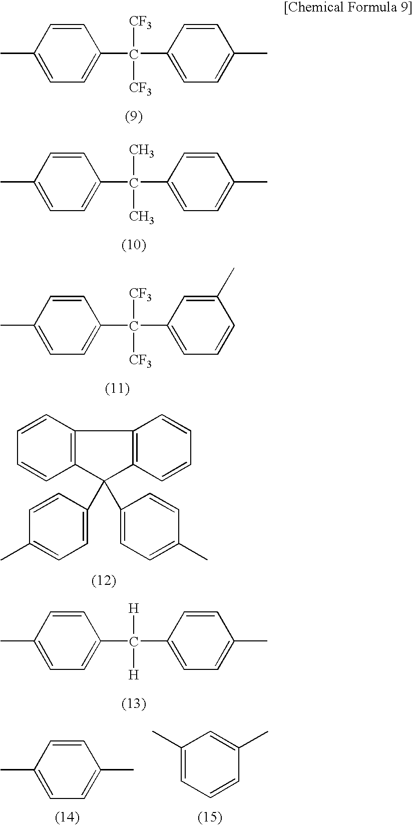

In the above formula (7), R¹ is preferably a group represented by the following formula (16). In the following formula (16), R² and p are defined as those in the above formula (8).

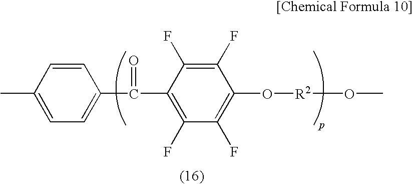

In the above formula (7), n represents a degree of polymerization. n falls within a range of 2 to 5,000, preferably within a range of 5 to 500, for example. Polymerization may involve polymerization of repeating units of the same structure or polymerization of repeating units of different structures. In the latter case, a polymerization form of the repeating units may be block polymerization or random polymerization.

Terminals of the polyaryletherketone represented by the above formula (7) are preferably a fluorine atom on a p-tetrafluorobenzoylene group side and a hydrogen atom on an oxyalkylene group side. Such polyaryletherketone can be represented by the following general formula (17), for example. In the following formula (17), n represents the same degree of polymerization as that in the above formula (7).

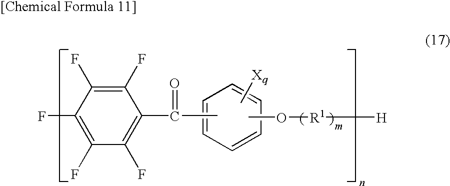

Specific examples of the polyaryletherketone represented by the above formula (7) include compounds represented by the following formulae (18) to (21). In each of the following formulae, n represents the same degree of polymerization as that in the above formula (7).

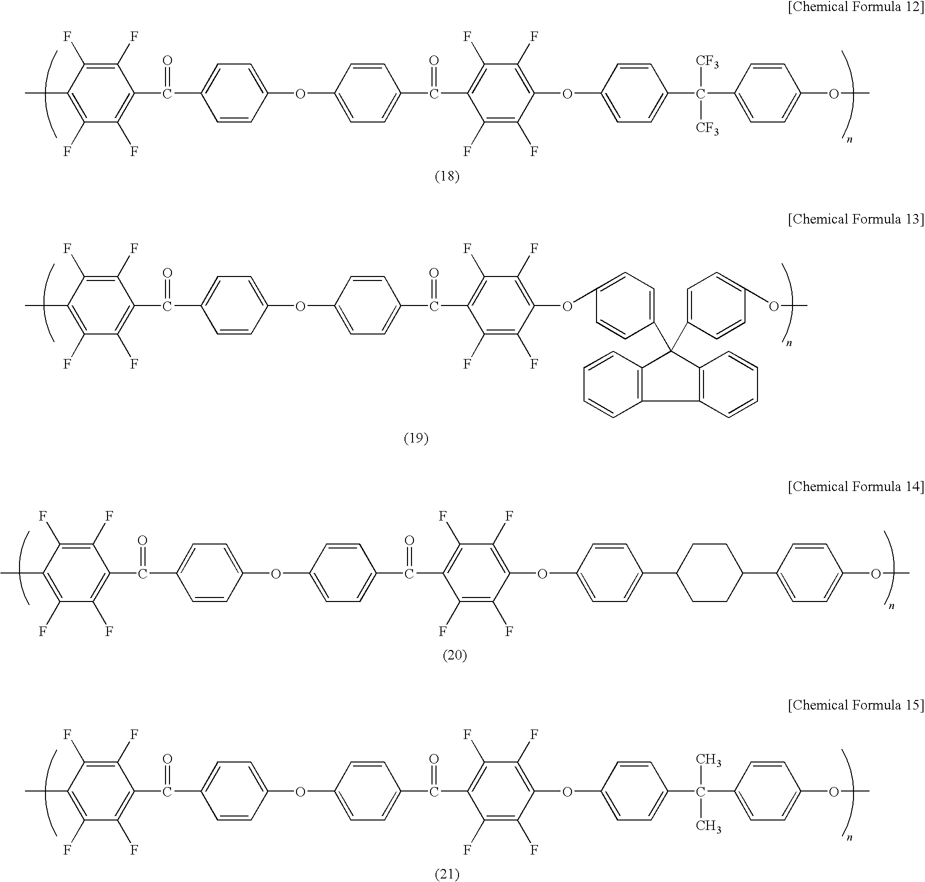

In addition, an example of polyamide or polyester includes polyamide or polyester disclosed in JP 10-508048 A. A repeating unit thereof can be represented by the following general formula (22), for example.

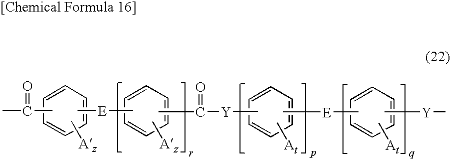

In the above formula (22), Y represents O or NH. E represents at least one selected from a covalent bond, an alkylene group having 2 carbon atoms, a halogenated alkylene group having 2 carbon atoms, a CH₂ group, a C(CX₃)₂ group (wherein, X is a halogen or hydrogen), a CO group, an O atom, an S atom, an SO₂ group, an Si(R)₂ group, and an N(R) group, for example. A plurality of Es may be the same or different from each other. In E, R is at least one of an alkyl group having 1 to 3 carbon atoms and a halogenated alkyl group having 1 to 3 carbon atoms, and is located in a meta or para position with respect to a carbonyl functional group or a Y group.

In the above formula (22), A and A′ each represent a substituent, and t and z represent the numbers of the respective substituents. p represents an integer of 0 to 3, and q represents an integer of 1 to 3. r represents an integer of 0 to 3.

A is selected from hydrogen, a halogen, an alkyl group having to 3 carbon atoms, a halogenated alkyl group having 1 to 3 carbon atoms, an alkoxy group represented by OR (wherein, R is defined as above), an aryl group, a substituted aryl group prepared through halogenation or the like, an alkoxycarbonyl group having 1 to 9 carbon atoms, an alkylcarbonyloxy group having 1 to 9 carbon atoms, an aryloxycarbonyl group having 1 to 12 carbon atoms, an arylcarbonyloxy group having 1 to 12 carbon atoms and its substituted derivatives, an arylcarbamoyl group having 1 to 12 carbon atoms, and arylcarbonylamino group having 1 to 12 carbon atoms and its substituted derivatives, for example. A plurality of As may be the same or different from each other. A′ is selected from a halogen, an alkyl group having 1 to 3 carbon atoms, a halogenated alkyl group having 1 to 3 carbon atoms, a phenyl group, and a substituted phenyl group, for example. A plurality of A's may be the same or different from each other. Examples of the substituent on a phenyl ring of the substituted phenyl group include a halogen, an alkyl group having 1 to 3 carbon atoms, a halogenated alkyl group having 1 to 3 carbon atoms, and the combination thereof. t represents an integer of 0 to 4, and z represents an integer of 0 to 3.

The repeating unit of the polyamide or polyester represented by the above formula (22) is preferably a repeating unit represented by the following general formula (23).

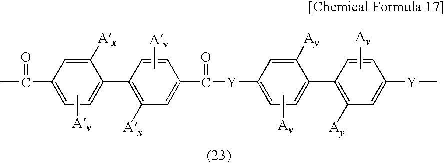

In the above formula (23), A, A′, and Y are defined as those in the above formula (22). v represents an integer of 0 to 3, preferably an integer of 0 to 2. x and y are each 0 or 1, but are not both 0.

### B-3. Method of Forming an Optical Compensation Layer

Next, a method of forming an optical compensation layer will be described. As the method of forming an optical compensation layer, any appropriate method can be adopted as long as an optical compensation layer having the above-mentioned optical properties is obtained. A typical formation method includes a step of applying the non-liquid crystalline polymer to a base material film, and a step of removing a solvent in the solution to form a layer of anon-liquid crystalline polymer. Typically, the base material film finally becomes the first or second protective layer. Thus, a film (typically, a cellulose-based film) constituting the first and second protective layers is used as a base material film. The detail of the cellulose-based film will be described later in an item D.

Examples of the solvent for applying the solution (non-liquid crystalline polymer solution) include, but are not particularly limited to: halogenated hydrocarbons such as chloroform, dichloromethane, carbon tetrachloride, dichloroethane, tetrachloroethane, trichloroethylene, tetrachloroethylene, chlorobenzene, and orthodichlorobenzene; phenols such as phenol and varachlorophenol; aromatic hydrocarbons such as benzene, toluene, xylene, methoxybenzene, and 1,2-dimethoxybenzene; ketone-based solvents such as acetone, methyl ethyl ketone, methyl isobutyl ketone, cyclohexanone, cyclopentanone, 2-pyrrolidone, and N-methyl-2-pyrrolidone; ester-based solvents such as ethyl acetate and butyl acetate; alcohol-based solvents such as t-butyl alcohol, glycerin, ethylene glycol, triethylene glycol, ethylene glycol monomethyl ether, diethylene glycol dimethyl ether, propylene glycol, dipropylene glycol, and 2-methyl-2,4-pentanediol; amide-based solvents such as dimethylformamide and dimethylacetamide; nitrile-based solvents such as acetonitrile and butyronitrole; ether-based solvents such as diethyl ether, dibutyl ether, and tetrahydrofuran; and carbon disulfide, ethyl cellosolve, and butyl cellosolve. Of those, methyl isobutyl ketone is preferred because it indicates high solubility with non-liquid crystalline materials and does not corrode the base material film. The solvents may be used alone or in combination.

As the concentration of the non-liquid crystalline polymer in the applying solution, any appropriate concentration can be adopted as long as the above-mentioned optical compensation layer is obtained and application can be performed. For example, the applying solution contains a non-liquid crystalline polymer in an amount of preferably 5 to 50 parts by weight, and more preferably 10 to 40 parts by weight with respect to 100 parts by weight of the solvent. The solution in such a concentration range has viscosity that makes application easier.

The applying solution can further contain various additives such as a stabilizer, a plasticizer, and metals as required.

The applying solution can further contain other different resins as required. Examples of such other resins include various kinds of general-purpose resins, an engineering plastic, a thermoplastic resin, and a thermosetting resin. By using such resins together, an optical compensation layer having suitable mechanical strength and durability in accordance with the purpose can be formed.

Examples of the general-purpose resin include polyethylene (PE), polypropylene (PP), polystyrene (PS), polymethylmethacrylate (PMMA), an ABS resin, and an AS resin. Examples of the engineering plastic include polyacetate (POM), polycarbonate (PC), polyamide (PA: nylon), polyethylene terephthalate (PET), and polybutylene terephthalate (PBT). Examples of the thermoplastic resin include polyphenylenesulfide (PPS), polyethersulfon (PES), polyketone (PK), polyimide (PI), polycyclohexanedimethanol terephthalate (PCT), polyarylate (PAR), and a liquid crystal polymer (LCP). Examples of the thermosetting resin include an epoxy resin and a phenol novolak resin.

The kind and amount of the different resins added to the applying solution can be set appropriately in accordance with the purpose. For example, the resin can be added to the non-liquid crystalline polymer in an amount of preferably 0 to 50 mass %, and more preferably 0 to 30 mass %.

Examples of the application methods for the applying solution include spin coating, roll coating, flow coating, printing, dip coating, casting deposition, bar coating, and gravure printing. Further, in application, a method of superimposing a polymer layer may also be employed as required.

After the application, for example, a solvent in the above solution is evaporated and removed by drying such as natural drying, air drying, and heat drying (e.g., 60 to 250° C.), whereby the optical compensation layer is formed on the base material film (which finally forms the first or second protective layer).

Preferably, in the method of forming an optical compensation layer, the treatment for providing optical biaxiality (nx>ny>nz) can be performed. By conducting such a treatment, the difference in a refractive index (nx>ny) can be provided in a plane without fail, whereby an optical compensation layer having an optical biaxiality (nx>ny>nz) is obtained. Typically, an example of the method of providing the difference in a refractive index in a plane includes the method of integrally stretching or shrinking the base material film and the optical compensation layer formed on the base material film. In a preferred embodiment, the base material film and the optical compensation layer formed thereon are stretched or shrunk by heating them to a predetermined temperature. The heating temperature (stretching temperature) is, for example, 120° C. to 180° C., and the stretch ratio is, for example, 1.1 to 1.5 times, and preferably 1.1 to 1.3 times. Thus, an optical compensation layer is formed (in other words, a laminate of an optical compensation layer and a protective layer is obtained). As the base material film, any appropriate film not constituting a protective layer may be used. In this case, the formed optical compensation layer can be transferred from a base material film to a protective layer or a polarizer.

### C. Polarizer

Any appropriate polarizer may be employed as the first polarizer 10 and the second polarizer 50 used in the present invention depending on the purpose. Examples thereof include: a film prepared by adsorbing a dichromatic substance such as iodine or a dichromatic dye on a hydrophilic polymer film such as a polyvinyl alcohol-based film, a partially formalized polyvinyl alcohol-based film, or a partially saponified ethylene/vinyl acetate copolymer-based film and uniaxially stretching the film; and a polyene-based orientation film such as a dehydrated product of a polyvinyl alcohol-based film or a dechlorinated product of a polyvinyl chloride-based film. Of those, a polarizer prepared by adsorbing a dichromatic substance such as iodine on a polyvinyl alcohol-based film and uniaxially stretching the film is particularly preferred because of its high polarized dichromaticity. The thicknesses of the polarizers are generally about 5 to 80 μm, though they are not particularly limited thereto. The first polarizer 10 and the second polarizer 50 may be the same as or different to each other.

The polarizer prepared by adsorbing iodine on a polyvinyl alcohol-based film and uniaxially stretching the film may be produced by, for example: immersing the polyvinyl alcohol in an aqueous solution of iodine for coloring; and stretching the film to a 3 to 7 times length of the original length. The aqueous solution may contain boric acid, zinc sulfate, zinc chloride, or the like as required, or the polyvinyl alcohol-based film may be immersed in an aqueous solution of potassium iodide or the like. Further, the polyvinyl alcohol-based film may be immersed and washed in water before coloring as required. Washing the polyvinyl alcohol-based film with water not only allows removal of contamination on a film surface or washing away of an antiblocking agent, but also provides an effect of preventing unevenness such as uneven coloring by swelling of the polyvinyl alcohol-based film. The stretching of the film may be performed after coloring of the film with iodine, performed during coloring of the film, or performed followed by coloring of the film with iodine. The stretching may be performed in an aqueous solution of boric acid or potassium iodide, or in a water bath.

### D. First and Second Protective Layers

As described above, the liquid crystal panel of the present invention further includes a first protective layer (not shown) between the first optical compensation layer 20 and the first polarizer 10, and/or a second protective layer between the second optical compensation layer 40 and the second polarizer 50. Further preferably, the liquid crystal panel of the present invention further includes a first protective layer between the first optical compensation layer 20 and the first polarizer 10, and a second protective layer between the second optical compensation layer 40 and the second polarizer 50. By providing the protective layer between the optical compensation layer and the polarizer, the degradation in the polarizer can be prevented, and the adhesive property (as a result, durability) between the polarizer and the optical compensation layer can be improved. Typically, the first optical compensation layer 20 and the first protective layer, and the second optical compensation layer 40 and the second protective layer are laminated directly. For example, as described in the above item B-3, by applying and drying a material for forming the optical compensation layer on a film constituting the protective layer, the protective layer and the optical compensation layer can be laminated directly. Further, typically, the first polarizer 10 and the first protective layer, and the second polarizer 50 and the second protective layer are laminated via any appropriate adhesive layer. The first protective layer and the second protective layer may have the same properties (e.g., optical properties, mechanical properties, thermal properties), or may have different properties. Preferably, the first protective layer and the second protective layer are the same. This is because a color shift can be improved remarkably.

It is preferred that the first and second protective layers (protective layer on a liquid crystal cell side of the polarizer) have its optical properties optimized. More specifically, the in-plane retardation Δndₚ₁ and Δndₚ₂ of the first and second protective layers, respectively, are preferably 15 nm or less, more preferably 10 nm or less, particularly preferably 6 nm or less, especially preferably 4 nm or less, and most preferably 2 nm or less. On the other hand, each of Δndₚ₁ and Δndₚ₂ is preferably 0 nm or more, and more preferably more than 0 nm. According to the present invention, by incorporating a combination of the protective layer (protective layer on an inner side of the polarizer) having the in-plane retardation Δnd in the above range and the particular optical compensation layer as described above in the liquid crystal panel, a color shift can be made very small. Δndₚ₁ and Δndₚ₂ may be the same as or different to each other. Preferably, Δndₚ₁ and Δndₚ₂ are the same. This is because a color shift can be improved remarkably.

The retardation Rthₚ₁ and Rthₚ₂ in a thickness direction of the first and second protective layers, respectively, are preferably 70 nm or less, more preferably 60 nm or less, particularly preferably 30 nm or less, especially preferably 20 nm or less, and most preferably 10 nm or less. On the other hand, each of Rthₚ₁ and Rthₚ₂ is preferably 0 nm or more, and more preferably more than 0 nm. In one embodiment, at least one of the thickness direction retardation Rthₚ₁ and Rthₚ₂ of the first and second protective layers is 30 nm or less. According to the present invention, by incorporating a combination of the protective layer (protective layer on an inner side of the polarizer) having the thickness direction retardation Rth in the above range and the particular optical compensation layer as described above in the liquid crystal panel, a color shift can be made very small. Rthₚ₁ and Rthₚ₂ may be the same as or different to each other. Preferably, Rthₚ₁ and Rthₚ₂ are the same. This is because a color shift can be improved remarkably.

As the materials for the first and second protective layers, any appropriate material can be adopted. Examples of the material include a cellulose-based material and a norbornene-based material. One preferred specific example has a configuration in which the first and second protective layers are composed of a film (cellulose-based film) obtained from a cellulose-based material. As the cellulose-based film, any appropriate cellulose-based film is used as long as the effects of the present invention are obtained. The first and second protective layers may be composed of the same cellulose-based film, or different cellulose-based films. It is preferred that the first and second protective layers be composed of the same cellulose-based film. This is because a color shift can be improved remarkably. As a specific example of a cellulose-based material constituting the film, there is mentioned an aliphatic acid-substituted cellulose-based polymer such as diacetyl cellulose and triacetyl cellulose.

As long as the optical properties as described above are optimized, a cellulose-based film (for example, TF80UL (trade name) manufactured by Fujifilm Corporation) used generally as a transparent protective film may be used as it is, or a cellulose-based film subjected to a suitable treatment (for example, treatment of decreasing the thickness direction retardation (Rth)) may be used. Further, a commercially available cellulose-based film (for example, ZRF80S manufactured by Fujifilm Corporation) with the thickness direction retardation (Rth) controlled to be decreased may be used.

As the treatment of decreasing the thickness direction retardation (Rth), any appropriate treatment method can be adopted. Examples of the treatment include: a method of attaching a base material made of polyethylene terephthalate, polypropylene, or stainless steel with a solvent such as cyclopentanone or methylethylketone applied thereto to a general cellulose-based film, heat-drying the laminate (for example, to about 80° C. to 150° C. for about 3 to 10 minutes), and peeling the base material film; and a method of applying a solution in which a norbornene-based resin, an acrylic resin, or the like is dissolved in a solvent such as cyclopentanone or methylethylketone to a general cellulose-based film, heat-drying the laminate (for example, to about 80° C. to 150° C. for about 3 to 10 minutes), and peeling the applied film.

As the above-mentioned aliphatic acid-substituted cellulose-based polymer, an aliphatic acid-substituted cellulose-based polymer with an aliphatic acid substitution degree controlled is preferred. For example, in generally used triacetyl cellulose, the acetic acid substitution degree is about 2.8. However, preferably by controlling the acetic acid substitution to be 1.8 to 2.7, and more preferably by controlling the propionic acid substitution degree to be 0.1 to 1, the thickness direction retardation (Rth) can be controlled to be small.

In one embodiment, by adding a plasticizer such as dibutylphthalate, p-toluenesulfonanilide, or acetyl triethyl citric acid to the aliphatic acid-substituted cellulose-based polymer, the thickness direction retardation (Rth) can be controlled to be small. The addition amount of the plasticizer is preferably 40 parts by weight or less, more preferably 1 to 20 parts by weight, and most preferably 1 to 15 parts by weight, with respect to 100 parts by weight of the aliphatic acid-substituted cellulose-based polymer.

The technology for controlling the thickness direction retardation (Rth) to be small as described above may be combined appropriately.

Another preferred specific example of the first and second protective layers include an acrylic resin film. Both of the first and second protective layers may be composed of acrylic resin films, or only one of them may be composed of an acrylic resin film. In the case where both the first and second protective layers are composed of acrylic resin films, they may be the same acrylic resin films or different acrylic resin films. The acrylic resin film is preferably an acrylic resin film containing as a main component an acrylic resin (A) containing a glutaric anhydride unit represented by the following structural formula (24) disclosed in JP 2005-314534 A. The acrylic resin film has its heat resistance enhanced by containing the glutaric anhydride unit represented by the following structural formula (24). In the following structural formula (24), R¹ and R² represent hydrogen atoms that are the same as or different to each other, or alkyl groups having 1 to 5 carbon atoms, preferably hydrogen atoms or methyl groups, and more preferably methyl groups.

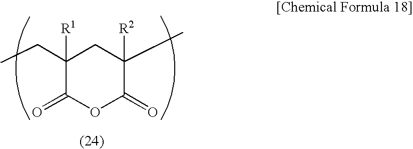

In the acrylic resin (A), the content ratio of the glutaric anhydride represented by the structural formula (24) is preferably 20 to 40% by weight, and more preferably 25 to 35% by weight.

The acrylic resin (A) may contain one kind or two or more kinds of any appropriate monomer units, in addition to the glutaric anhydride represented by the above structural formula (24). An example of such a monomer unit preferably includes a vinylcarboxylic acid alkyl ester unit. In the acrylic resin (A), the content ratio of the vinylcarboxylic acid alkyl ester is preferably 60 to 80% by weight, and more preferably 65 to 75% by weight.

As the vinylcarboxylic acid alkyl ester, for example, there is a unit represented by the following general formula (25). In the following general formula (25), R³ represents a hydrogen atom or an aliphatic or alicyclic hydrocarbon containing 1 to 5 carbon atoms, and R⁴ represents an aliphatic hydrocarbon containing 1 to carbon atoms.

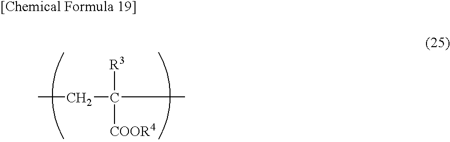

The weight average molecular weight of the acrylic resin (A) is preferably 80,000 to 150,000.

The content ratio of the acrylic resin (A) in the above acrylic resin film is preferably 60 to 90% by weight.

The acrylic resin film may contain one kind or two or more kinds of any appropriate components in addition to the above acrylic resin (A). As such a component, any appropriate component can be adopted in such a range so as not to impair the object of the present invention. Examples of any appropriate component include a resin other than the acrylic resin (A), a UV-absorber, an antioxidant, a lubricant, a plasticizer, a release agent, a color protection agent, a flame retardant, a nucleating agent, an antistatic agent, a pigment, and a colorant.

As the thicknesses of the first and second protective layers, any appropriate thickness can be adopted as long as a desired thickness direction retardation (Rth) is obtained and the mechanical strength as the protective layer (protective film) is maintained. Specifically, the thickness of each of the first and second protective layers is preferably 1 to 500 μm, more preferably 5 to 200 μm, particularly preferably 20 to 200 μm, especially preferably 30 to 100 μm, and most preferably 35 to 95 μm. The thicknesses of the first and second protective layers may be the same as or different to each other. Preferably, the thicknesses of the first and second protective layers are the same. This is because a color shift can be improved remarkably.

### E. Another Protective Layer (Outer Protective Layer)

Practically, another protective layer (not shown) is provided on an outer side (viewer side of an illustrated example) of the first polarizer 10, and still another protective layer (not shown) is provided on an outer side (backlight side of the illustrated example) of the second polarizer 50. The outer protective layers do not influence on the optical compensation, so the optical properties do not need to be optimized. Thus, as the outer protective layers, any appropriate protective layers can be adopted in accordance with the purpose. The outer protective layer is formed of a plastic film excellent in transparency, mechanical strength, heat stability, moisture barrier properties, isotropy, and the like. Specific examples of the resin used for forming the plastic film include an acetate resin such as triacetyl cellulose (TAC), a polyester resin, a polyether sulfone resin, a polysulfone resin, a polycarbonate resin, a polyamide resin, a polyimide resin, a polyolefin resin, an acrylic resin, a polynorbornene resin, a cellulose resin, a polyallylate resin, a polystyrene resin, a polyvinyl alcohol resin, a polyacrylic resin, and a mixture thereof. Further, an acrylic, urethane-based, acrylic urethane-based, epoxy-based, and silicone-based thermosetting resin or UV-curable resin may also be used. From viewpoints of polarization properties and durability, a TAC film having a surface subjected to saponification treatment with an alkali or the like is preferred.

Further, a polymer film formed of a resin composition as disclosed in JP 2001-343529 A (WO 01/37007) may also be used for the outer protective layer. More specifically, the film is a mixture of a thermoplastic resin having a substituted or unsubstituted imide group on a side chain and a thermoplastic resin having a substituted phenyl group or unsubstituted phenyl group and a cyano group on a side chain. A specific example thereof includes a resin composition containing an alternate copolymer of isobutene and N-methylmaleimide, and an acrylonitrile/styrene copolymer. The polymer film may be an extruded product of the above resin composition, for example.

It is preferred that the outer protective layer be transparent and have no color. Specifically, the outer protective layer has a thickness direction retardation Rth of preferably −90 nm to +75 nm, more preferably −80 nm to +60 nm, and most preferably −70 nm to +45 nm. If the thickness direction retardation Rth of the outer protective layer is in such a range, the optical coloring of the polarizer ascribed to the outer protective layer can be eliminated.

The thickness of the outer protective layer can be set appropriately in accordance with the purpose. The thickness of the outer protective layer is typically 500 μm or less, preferably 5 to 300 μm, and more preferably 5 to 150 μm.

The surface of the outer protective layer, with which the polarizer is not brought into contact, can be subjected to any appropriate surface treatment. Specific examples of the surface treatment include a hard coat treatment, an antireflection treatment, a sticking prevention treatment, and a diffusion treatment (which may also be referred to as an antiglare treatment). The hard coat treatment is conducted for a purpose of preventing the damage of the surface of a polarizing plate, and for example, a curable coating film excellent in hardness, slip properties, and the like, made of an appropriate acrylic or silicone-based UV-curable resin can be formed on the surface of the protective layer. The antireflection treatment is conducted for the purpose of preventing the reflection of outdoor light on the surface of the polarizing plate. Further, the sticking prevention treatment is conducted for the purpose of preventing the adhesion with an adjacent layer. The antiglare treatment is performed for the purpose of preventing outdoor light from being reflected from the surface of the polarizing plate to inhibit the visual recognition of light transmitted through the polarizing plate, and can be performed by providing a minute uneven structure on the surface of the protective layer by an appropriate system such as a roughening system based on a sandblast system or emboss processing system, or a compounding system of transparent particles. Further, the antiglare layer formed by the antiglare may also function as a diffusion layer (viewing angle enlargement function, etc.) for enlarging the viewing angle or the like by diffusing light transmitted through the polarizing plate.

### F. Liquid Crystal Display Apparatus

The liquid crystal display apparatus according to a preferred embodiment of the present invention is configured so as to include the liquid crystal panel of the present invention. As constituent members other than the liquid crystal panel, any appropriate constituent members are adopted. For example, the liquid crystal display apparatus of the present invention includes the liquid crystal panel of the present invention, surface treatment layers placed on both sides of the liquid crystal panel, a brightness enhancement film placed on an outer side (backlight side) of a surface treatment layer on the backlight side, a prism sheet, a light guide plate, and a backlight. As the surface treatment layer, a treatment layer subjected to the above hard coat treatment, antireflection treatment, sticking prevention treatment, diffusion treatment (antiglare treatment), etc. is used. The surface treatment layer may be formed by subjecting the outer protective layer to a surface treatment.

Hereinafter, the present invention will be specifically described by way of examples. However, the present invention is not limited to the examples. Methods of measuring properties in the examples are as described below.

### (1) Measurement of Retardation

Refractive indices nx, ny, and nz of a sample film were measured with an automatic birefringence analyzer (automatic birefringence analyzer KOBRA21-ADH manufactured by Oji Scientific Instruments), and an in-plane retardation And a thickness direction retardation Rth were calculated. A measurement temperature was 23° C., and a measurement wavelength was 590 nm.

### (2) Measurement of Color Shift

Color tones of a liquid crystal display apparatus were measured by changing a polar angle in a range of 0° to 80° in directions of azimuth angles of 30°, 45°, and 60°, using “EZ Contrast 160D” (trade name) manufactured by ELDIM, and plotted on an XY chromaticity diagram. Further, an x-value and a y-value were measured by changing the azimuth angle in a range of 0° to 60° in a direction of a polar angle of 60°, whereby the relationship between the azimuth angle, and the x-value and the y-value was plotted.

### Example 1

Polyimide represented by the following formula (6), synthesized from 2,2-bis(3,4-dicarboxyphenyl)hexafluoropropane dianhydride (6FDA) and 2,2′-bis(trifluoromethyl)-4,4′-diaminobiphenyl (TFMB), and having a weight average molecular weight (Mw) of 70,000 was dissolved in methyl isobutyl ketone, to thereby prepare a 10 mass % polyimide solution. Note that preparation of polyimide or the like was carried out by referring to the method described in the document (F. Li et al., Polymer 40 (1999) 4571-4583). The polyimide solution was applied to a thickness of 22 μm to a triacetylcellulose (TAC) film (ZRF80S (trade name) with a thickness of 80 μm, manufactured by Fujifilm Corporation) having a small retardation, and dried at 120° C. for 5 minutes, whereby a laminate including a base material (TAC film: which is finally to be a protective layer) and an optical compensation layer (2.2 μm thick) was obtained. The laminate was stretched laterally by 1.2 times at 150° C. The in-plane retardation of the laminate obtained by stretching was 43 nm, and the thickness direction retardation thereof was 192 nm. On the other hand, a retardation was measured by stretching only the base material (TAC film) similarly to reveal that the in-plane retardation was 4 nm and the thickness direction retardation was 20 nm. The retardation of the optical compensation layer (polyimide layer) was calculated from the difference between the retardation of the laminate and the retardation of the base material. The in-plane retardation of the optical compensation layer (polyimide layer) was 39 nm, and the thickness direction retardation thereof was 172 nm. Further, the Nz coefficient of the optical compensation layer was 4.4.

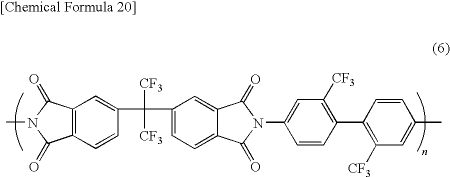

On the other hand, the polyvinyl alcohol film was dyed in an aqueous solution containing iodine, and then, was stretched uniaxially by 6 times between rolls having a different speed ratio in an aqueous solution containing boric acid to produce a polarizer. The polarizer and the laminate were attached to each other via an adhesive. At this time, the polarizer and the laminate were attached so that the base material (protective layer) and the polarizer were adjacent to each other. Further, the polarizer and the laminate were attached so that the absorption axis (stretch axis) of the polarizer and the slow axis (stretch axis) of the optical compensation layer were perpendicular to each other. Further, a generally used TAC film (TF80UL (trade name) with a thickness of 80 μm, manufactured by Fujifilm Corporation) was attached to the surface of the polarizer on which the laminate was not attached via an adhesive. Thus, a polarizing plate-integrated laminate having a configuration of outer protective layer (general TAC film)/polarizer/inner protective layer (TAC film having a small retardation)/optical compensation layer (polyimide layer) was obtained. Two polarizing plate-integrated laminates above were produced.

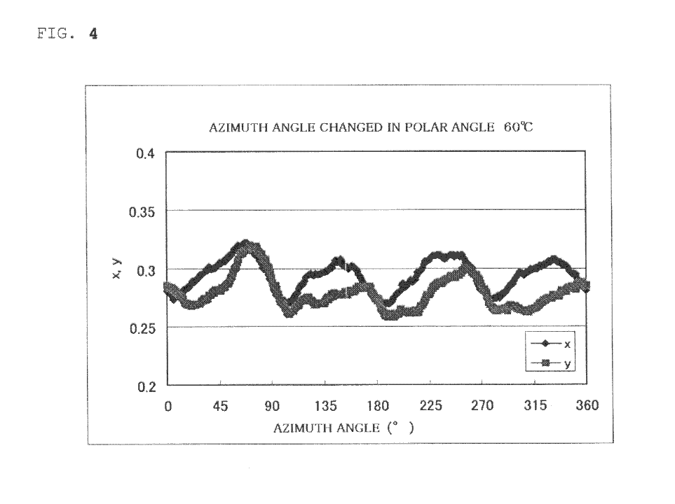

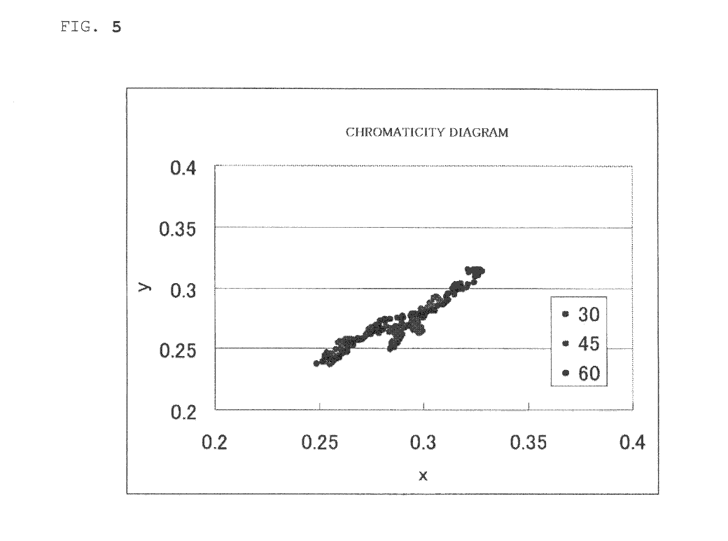

A liquid crystal cell was taken out from a liquid crystal panel (BenQ DV3250 (trade name) of 32 inches in a VA mode, manufactured by AUO). The two polarizing plate-integrated laminates were attached to both sides of the liquid crystal cell via an adhesive so that the respective outer protective layers were outermost layers. At this time, the polarizing plate-integrated laminates were attached to both sides of the liquid crystal cell so that the absorption axes of the respective polarizers were perpendicular to each other. Thus, a liquid crystal panel was obtained. The liquid crystal panel was measured for a color shift. FIG. 4 shows the relationship between an x-value and a y-value, and an azimuth angle, and FIG. 5 shows an xy chromaticity diagram. Further, Table 1 shows an (X, Y) value, an (Xᵢ, Yᵢ) value, a ΔXY-value, a (u′, v′) value, a (u′i, v′i) value, and a Δu′v′-value. The ΔXY-value is presented by the following Expression (A). The ΔXY-value represents the distance between the chromaticity (X, Y) in the case where the liquid crystal cell was observed from a normal direction and the point (Xi, Yi) farthest from the (X, Y) on the chromaticity diagram. As the value is larger, a color shift is larger. The Δu′v′-value is represented by the following Expression (B). The Δu′v′-value represents the distance between the chromaticity (u′, v′) in the case where the liquid crystal cell was observed from a normal direction and the point (u′i, v′i) farthest from the (u′, v′) on the chromaticity diagram. As this value is larger, a color shift is larger.

ΔXY={(X−Xi)²+(Y−Yi)}^{1/2} (A)

Δu′v′={(u′−u′i)²+(v′−v′i)^{1/2} (B)

TABLE 1

| | | | Comparative | Comparative |
|---|---|---|---|---|
| | Example 1 | Example 2 | Example 1 | Example 3 |
| (X, Y) | (0.24864, 0.23771) | (0.30039, 0.30074) | (0.24698, 0.24117) | (0.29844, 0.28973) |
| (Xi, Yi) | (0.32034, 0.31977) | (0.29028, 0.30421) | (0.33435, 0.33613) | (0.38831, 0.34513) |
| ΔXY | 0.109 | 0.04 | 0.129 | 0.106 |
| (u′, v′) | (0.18572, 0.39949) | (0.19999, 0.45050) | (0.18496, 0.38878) | (0.20303, 0.44347) |
| (u′i, v′i) | (0.20679, 0.46444) | (0.20812, 0.47374) | (0.20487, 0.46485) | (0.24680, 0.48642) |
| Δu′v′ | 0.068 | 0.025 | 0.079 | 0.061 |

### Example 2

The polyimide solution similar to Example 1 was applied to a thickness of 32 μm to a generally used TAC film (TF80UL (trade name) with a thickness of 80 μm, manufactured by Fujifilm Corporation), and dried at 120° C. for 5 minutes, whereby a laminate including a base material (TAC film: which is finally to be a protective layer) and an optical compensation layer (3.2 μm thick) was obtained. The laminate was stretched laterally by 1.27 times at 165° C. The in-plane retardation of the laminate obtained by stretching was 38 nm, and the thickness direction retardation thereof was 144 nm. On the other hand, a retardation was measured by stretching only the base material (TAC film) similarly to reveal that the in-plane retardation was 10 nm and the thickness direction retardation was 60 nm. The retardation of the optical compensation layer (polyimide layer) was calculated from the difference between the retardation of the laminate and the retardation of the base material. The in-plane retardation of the optical compensation layer (polyimide layer) was 28 nm, and the thickness direction retardation thereof was 84 nm. Further, the Nz coefficient of the optical compensation layer was 3.

On the other hand, a polarizer was produced similarly as that of Example 1. The polarizer and the laminate were attached to each other via an adhesive. At this time, the polarizer and the laminate were attached so that the base material (protective layer) and the polarizer were adjacent to each other. Further, the polarizer and the laminate were attached so that the absorption axis (stretch axis) of the polarizer and the slow axis (stretch axis) of the optical compensation layer were perpendicular to each other. Further, a generally used TAC film (TF80UL (trade name) with a thickness of 80 μm, manufactured by Fujifilm Corporation) was attached to the surface of the polarizer on which the laminate was not attached via an adhesive. Thus, a polarizing plate-integrated laminate having a configuration of outer protective layer (general TAC film)/polarizer/inner protective layer (general TAC film)/optical compensation layer (polyimide layer) was obtained. Two polarizing plate-integrated laminates were produced.

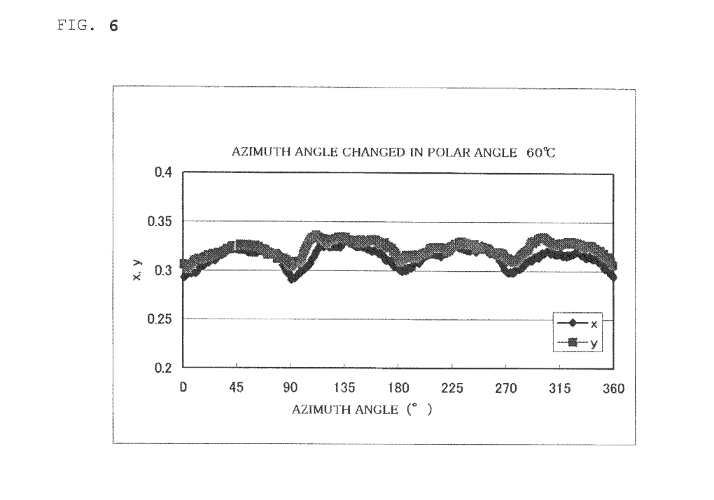

A liquid crystal cell was taken out from a liquid crystal panel (AQUOS (trade name) of 32 inches in a VA mode, manufactured by SHARP CORPORATION). The two polarizing plate-integrated laminates were attached to both sides of the liquid crystal cell via an adhesive. At this time, the polarizing plate-integrated laminates were attached to both sides of the liquid crystal cell so that the absorption axes of the respective polarizers were perpendicular to each other. Thus, a liquid crystal panel was obtained. The liquid crystal panel was measured for a color shift. FIG. 6 shows the relationship between an x-value and a y-value, and an azimuth angle. Further, the above Table 1 shows an (X, Y) value, an (Xᵢ, Yᵢ) value, a ΔXY-value, a (u′, v′) value, a (u′i, v′i) value, and a Δu′v′-value.

### Comparative Example 1

The polyimide solution similar to Example 1 was applied to a thickness of 31 μm to a generally used TAC film (TF80UL (trade name) with a thickness of 80 μm, manufactured by Fujifilm Corporation), and dried at 120° C. for 5 minutes, whereby a laminate including a base material (TAC film: which is finally to be a protective layer) and an optical compensation layer (3.1 μm thick) was obtained. The laminate was stretched laterally by 1.168 times at 160° C. The in-plane retardation of the laminate obtained by stretching was 55 nm, and the thickness direction retardation thereof was 260 nm. On the other hand, a retardation was measured by stretching only the base material (TAC film) similarly to reveal that the in-plane retardation was 10 nm and the thickness direction retardation was 60 nm. The retardation of the optical compensation layer (polyimide layer) was calculated from the difference between the retardation of the laminate and the retardation of the base material. The in-plane retardation of the optical compensation layer (polyimide layer) was 45 nm, and the thickness direction retardation thereof was 200 nm. Further, the Nz coefficient of the optical compensation layer was 4.4.

The later procedure was conducted in the same way as that of Example 1, whereby a polarizing plate-integrated laminate having a configuration of outer protective layer (general TAC film)/polarizer/inner protective layer (general TAC film)/optical compensation layer (polyimide layer) was obtained.

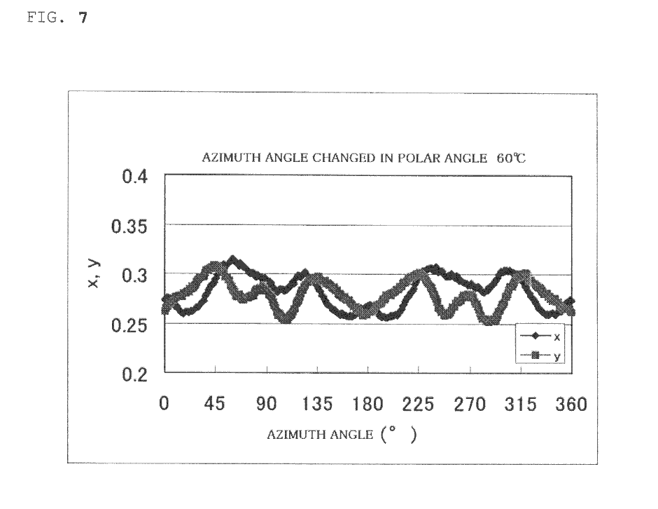

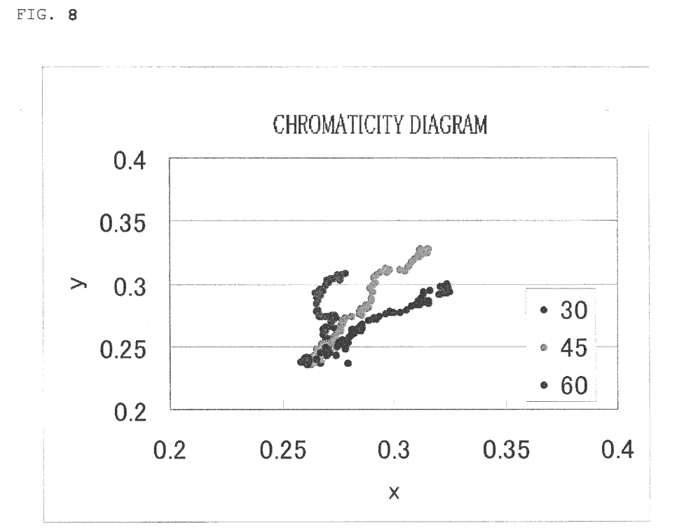

A liquid crystal cell was taken out from a liquid crystal panel (BenQ DV3250 (trade name) of 32 inches in a VA mode, manufactured by AUO). The polarizing plate-integrated laminate was attached to one side of the liquid crystal cell via an adhesive, and a commercially available polarizing plate (SEG1224 (trade name) manufactured by Nitto Denko Corporation) having a configuration of TAC/polarizer/TAC was attached to the other side via an adhesive. At this time, they were attached so that the absorption axes of the respective polarizers were perpendicular to each other. Thus, a liquid crystal panel was obtained. The liquid crystal panel was measured for a color shift. FIG. 7 shows the relationship between an x-value and a y-value, and an azimuth angle, and FIG. 8 shows an xy chromaticity diagram. Further, the above Table 1 shows an (X, Y) value, an (Xi, Yi) value, a ΔXY-value, a (u′, v′) value, a (u′i, v′i) value, and Δu′v′-value of the liquid crystal panel.

### Comparative Example 2

The polyimide solution similar to Example 1 was applied to a thickness of 42 μm to a TAC film (ZRF80S (tradename) with a thickness of 80 μm, manufactured by Fujifilm Corporation) having a small retardation, and dried at 120° C. for 5 minutes, whereby a laminate including a base material (TAC film: which is finally to be a protective layer) and an optical compensation layer (4.2 μm thick) was obtained. The laminate was stretched laterally by 1.2 times at 155° C. The in-plane retardation of the laminate obtained by stretching was 55 nm, and the thickness direction retardation thereof was 245 nm. On the other hand, a retardation was measured by stretching only the base material (TAC film) similarly to reveal that the in-plane retardation was 4 nm and the thickness direction retardation was 20 nm. The retardation of the optical compensation layer (polyimide layer) was calculated from the difference between the retardation of the laminate and the retardation of the base material. The in-plane retardation of the optical compensation layer (polyimide layer) was 51 nm, and the thickness direction retardation thereof was 225 nm. Further, the Nz coefficient of the optical compensation layer was 4.4.

The later procedure was conducted in the same way as that of Example 1, whereby a polarizing plate-integrated laminate having a configuration of outer protective layer (general TAC film)/polarizer/inner protective layer (TAC film having a small retardation)/optical compensation layer (polyimide layer) was obtained.

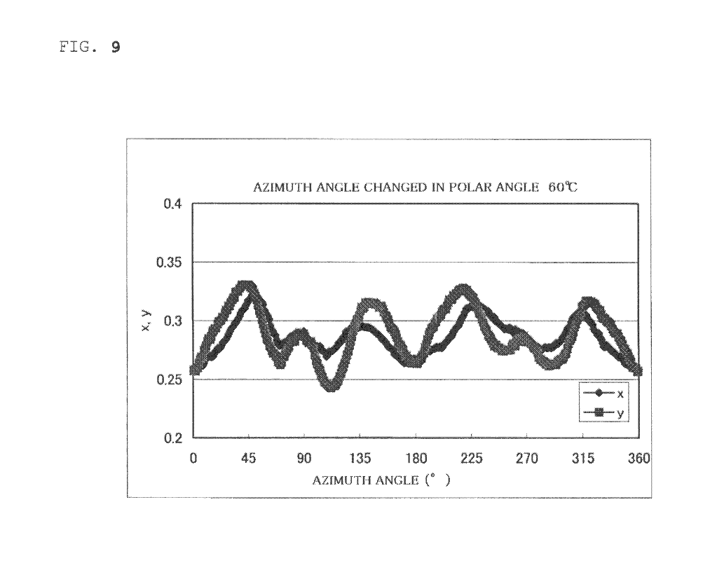

A liquid crystal cell was taken out from a liquid crystal panel (BenQ DV3250 (trade name) of 32 inches in a VA mode, manufactured by AUO). The polarizing plate-integrated laminate was attached to one side of the liquid crystal cell via an adhesive, and a commercially available polarizing plate (SEG1224 (trade name) manufactured by Nitto Denko Corporation) having a configuration of TAC/polarizer/TAC was attached to the other side via an adhesive. At this time, they were attached so that the absorption axes of the respective polarizers were perpendicular to each other. Thus, a liquid crystal panel was obtained. The liquid crystal panel was measured for a color shift. FIG. 9 shows the relationship between an x-value and a y-value, and an azimuth angle.

### Comparative Example 3

The polyimide solution similar to Example 1 was applied to a thickness of 31 μm to a generally used TAC film (TF80UL (trade name) with a thickness of 80 μm, manufactured by Fujifilm Corporation), and dried at 120° C. for 5 minutes, whereby a laminate including a base material (TAC film: which is finally to be a protective layer) and an optical compensation layer (3.1 μm thick) was obtained. The laminate was stretched laterally by 1.168 times at 160° C. The in-plane retardation of the laminate obtained by stretching was 50 nm, and the thickness direction retardation thereof was 270 nm. On the other hand, a retardation was measured by stretching only the base material (TAC film) similarly to reveal that the in-plane retardation was 10 nm and the thickness direction retardation was 60 nm. The retardation of the optical compensation layer (polyimide layer) was calculated from the difference between the retardation of the laminate and the retardation of the base material. The in-plane retardation of the optical compensation layer (polyimide layer) was 40 nm, and the thickness direction retardation thereof was 210 nm. Further, the Nz coefficient of the optical compensation layer was 5.3.

The later procedure was conducted in the same way as that of Example 1, whereby a polarizing plate-integrated laminate having a configuration of outer protective layer (general TAC film)/polarizer/inner protective layer (general TAC film)/optical compensation layer (polyimide layer) was obtained.

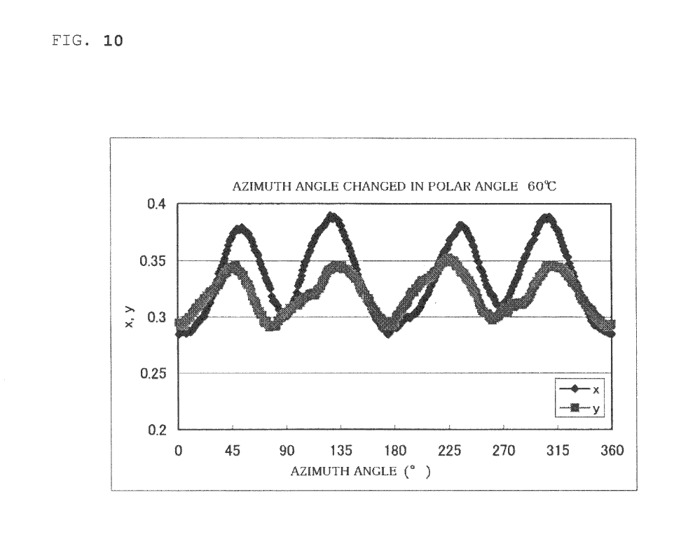

A liquid crystal cell was taken out from a liquid crystal panel (Aquos (trade name) of 32 inches in a VA mode, manufactured by SHARP CORPORATION). The polarizing plate-integrated laminate was attached to one side of the liquid crystal cell via an adhesive, and a commercially available polarizing plate (SEG1224 (trade name) manufactured by Nitto Denko Corporation) having a configuration of TAC/polarizer/TAC was attached to the other side via an adhesive. At this time, they were attached so that the absorption axes of the respective polarizers were perpendicular to each other. Thus, a liquid crystal panel was obtained. The liquid crystal panel was measured for a color shift. FIG. 10 shows the relationship between an x-value and a y-value, and an azimuth angle. Further, the above Table 1 shows an (X, Y) value, an (Xi, Yi) value, a ΔXY-value, a (u′, v′) value, a (u′i, v′i) value, and Δu′v′-value of the liquid crystal panel.

### (Evaluation)

As is apparent from the comparison between FIGS. 5 and 8, in the liquid crystal panel of Example 1, the color change tendency with respect to a polar angle is substantially constant irrespective of the azimuth angle, whereas, in the liquid crystal panel of Comparative Example 1, the color change tendency with respect to a polar angle changes largely depending upon the azimuth angle. From this, it is understood that the change in a color tone depending upon the observation direction is remarkably smaller in the liquid crystal panel of Example 1, compared with that of the liquid crystal panel of Comparative Example 1. Further, as is apparent from FIGS. 4, 6, 7, 9, and 10, in the liquid crystal panels of Examples of the present invention, the degree at which the curve of an x-value crosses the curve of a y-value with respect to an azimuth angle is remarkably smaller, compared with that of the liquid crystal panels of Comparative Examples. This also shows that in the liquid crystal panels of Examples of the present invention, the change in a color tone depending upon the observation direction is remarkably smaller, compared with that of the liquid crystal panels of Comparative Examples. In addition, as is apparent from Table 1, the ΔXY-value and the Δu′v′-value of the liquid crystal panel of Example 1 are significantly smaller from a practical point of view, compared with the ΔXY-value and the Δu′v′-value of the liquid crystal panel of Comparative Example 1, respectively. Further, the ΔXY-value and the Δu′v′-value of the liquid crystal panel of Example 2 are significantly smaller from a practical point of view, compared with the ΔXY-value and the Δu′v′-value of the liquid crystal panel of Comparative Example 3, respectively. From these results, it is understood that a color shift becomes remarkably smaller when predetermined optical compensation layers are placed on both sides of the liquid crystal cell, compared with the case where a predetermined optical compensation layer is placed on one side.

### INDUSTRIAL APPLICABILITY

The liquid crystal panel and liquid crystal display apparatus of the present invention may be suitably used for various applications including: office automation (OA) devices such as a personal computer monitor, a laptop computer, and a copying machine; portable devices such as a cellular phone, a watch, a digital camera, a personal digital assistance (PDA), and a portable game machine; home appliances such as a video camera, a liquid crystal television, and a microwave; on-vehicle devices such as a back monitor, a car navigation system monitor, and a car audio; display devices such as a commercial information monitor; security devices such as a surveillance monitor; and nursing care and medical devices such as a nursing monitor and a medical monitor.

1. A liquid crystal panel, comprising a first polarizer, a first optical compensation layer, a liquid crystal cell, a second optical compensation layer, and a second polarizer in the stated order,
wherein the first optical compensation layer and the second optical compensation layer each contain at least one polymer selected from the group consisting of polyimide, polyamide, polyester, polyetherketone, polyamideimide, and polyesterimide, and have a refractive index profile of nx>ny>nz,
where nx represents a refractive index in a slow axis direction of the optical compensation layer, ny represents a refractive index in a fast axis direction of the optical compensation layer, and nz represents refractive index in a thickness direction of the optical compensation layer.

2. A liquid crystal panel according to claim 1, wherein each of the first optical compensation layer and the second optical compensation layer has a thickness of 0.5 to 10 μm.

3. A liquid crystal panel according to claim 1 or 2, wherein each of the first optical compensation layer and the second optical compensation layer has a Nz coefficient of 2≦Nz≦20.

4. A liquid crystal panel according to claim 1 or 2, further comprising a first protective layer between the first optical compensation layer and the first polarizer, and a second protective layer between the second optical compensation layer and the second polarizer.

5. A liquid crystal panel according to claim 4, wherein the first protective layer and the second protective layer each contain a cellulose-based polymer, and a thickness direction retardation Rth of at least one of the first protective layer and the second protective layer is 30 nm or less,
where the thickness direction retardation Rth is represented
by an expression Rth=(nx−nz)×d, nx is a refractive index in a slow axis direction of the optical compensation layer, nz is a refractive index in a thickness direction of the optical compensation layer, and d is a thickness of the optical compensation layer.

6. A liquid crystal panel according to claim 1 or 2, wherein the liquid crystal cell is one of a VA mode and an OCB mode.

7. A liquid crystal display apparatus, comprising the liquid crystal panel according to claim 1 or 2.
